(19) United States
(12) Patent Application Publication
(10) Pub. No.: US 2011/0195324 A1
(43) Pub. Date: Aug. 11, 2011

(54) METHODS AND PROCESSES TO RECOVER VOLTAGE LOSS OF PEM FUEL CELL STACK

(75) Inventors: Jingxin Zhang, Pittsford, NY (US); Lesley Paine, Rochester, NY (US); Amit Nayar, Pittsford, NY (US); Rohit Makharia, Pittsford, NY (US)

(73) Assignee: GM GLOBAL TECHNOLOGY OPERATIONS, INC., DETROIT, MI (US)

(21) Appl. No.: 12/939,867

(22) Filed: Nov. 4, 2010

Related U.S. Application Data
(60) Provisional application No. 61/303,108, filed on Feb. 10, 2010.

(51) Int. Cl. H01M 8/06

(52) U.S. Cl. 429/413

(57) ABSTRACT

A system and method for recovering cell voltage loss in a PEM fuel cell stack that include operating the stack at conditions that provide excess water that flushes away contaminants deposited on the cell electrodes. Two techniques are described that both operate the stack at a relatively low temperature and a cathode inlet RH above saturation. The first technique also includes providing hydrogen to the anode side of the stack and air to the cathode side of the stack, and operating the stack at a relatively low cell voltage. The second technique also includes flowing hydrogen to the anode side of the stack and nitrogen to the cathode side of the stack, using an external power source to provide a stack current density, and providing an anode humidity level that is significantly higher than the cathode humidity level.

### CROSS-REFERENCE TO RELATED APPLICATIONS

This application claims the benefit of the priority date of U.S. Provisional Patent Application Ser. No. 61/303,108, titled Methods and Processes to Recover Voltage Loss of PEM Fuel Cell Stack, filed Feb. 10, 2010.

### BACKGROUND OF THE INVENTION

1. Field of the Invention

This invention relates generally to a system and method for recovering cell voltage loss in a PEM fuel cell stack and, more particularly, to a system and method for recovering cell voltage loss in a PEM fuel cell stack by providing stack operating conditions that generate significant stack water to flush away contaminants that have deposited on the cell electrodes.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte there between. The anode receives hydrogen gas and the cathode receives oxygen or air. The hydrogen gas is dissociated at the anode catalyst to generate free protons and electrons. The protons pass through the electrolyte to the cathode. The protons react with the oxygen and the electrons at the cathode catalyst to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically, but not always, include finely divided catalytic particles, usually a highly active catalyst such as platinum (Pt) that is typically supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

A fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow fields are provided on the anode side of the bipolar plates that allow the anode reactant gas to flow to the respective MEA. Cathode gas flow fields are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The membrane within a fuel cell needs to have sufficient water content so that the ionic resistance across the membrane is low enough to effectively conduct protons. Membrane humidification may come from the stack water by-product or external humidification. The flow of reactants through the flow channels of the stack has a drying effect on the cell membranes, most noticeably at an inlet of the reactant flow. However, the accumulation of water droplets within the flow channels could prevent reactants from flowing therethrough, and may cause the cell to fail because of low reactant gas flow, thus affecting stack stability. The accumulation of water in the reactant gas flow channels, as well as within the gas diffusion layer (GDL), is particularly troublesome at low stack output loads.

As mentioned above, water is generated as a by-product of the stack operation. Therefore, the cathode exhaust gas from the stack will typically include water vapor and liquid water. It is known in the art to use a water vapor transfer (WVT) unit to capture some of the water in the cathode exhaust gas, and use the water to humidify the cathode input airflow. Water in the cathode exhaust gas at one side of the water transfer elements, such as membranes, is absorbed by the water transfer elements and transferred to the cathode air stream at the other side of the water transfer elements.

There are a number of mechanisms that occur during the operation of a fuel cell system that cause permanent loss of stack performance, such as loss of catalyst activity, catalyst support corrosion and pinhole formation in the cell membranes. However, there are other mechanisms that can cause stack voltage losses that are substantially reversible, such as the cell membranes drying out, catalyst oxide formation, and contaminants depositing on both the anode and cathode side of the stack. Therefore, there is a need in the art to remove the oxide formations and the build-up of contaminants, as well as to rehydrate the cell membranes, to recover losses in cell voltage in a fuel cell stack.

In order for a PEM fuel cell system to be commercially viable, there generally needs to be a limitation of the noble metal loading, i.e., platinum or platinum alloy catalyst, on the fuel cell electrodes to reduce the overall system cost. As a result, the total available electro-chemically active surface area of the catalyst maybe limited or reduced, which renders the electrodes more susceptible to contamination. The source of the contamination can be from the anode and cathode reactant gas feed streams including humidification water, or generated within the fuel cells due to the degradation of the MEA, stack sealants and/or bipolar plates. One particular type of contaminate includes anions, which are negatively charged, such as chlorine or sulfates, such as SO₄². The anions tend to adsorb onto the platinum catalyst surface of the electrode during normal fuel cell operation when the cathode potential is typically over 650 mV, thus blocking the active site for oxygen reduction reaction, which leads to cell voltage loss. Moreover, if proton conductivity is also highly dependent on contaminate free platinum surface, such as nano-structured thin film (NSTF) type electrodes, additional losses are caused by the reduced proton conductivity.

### SUMMARY OF THE INVENTION

In accordance with the teachings of the present invention, a system and method are disclosed for recovering cell voltage loss in a PEM fuel cell stack that include operating the stack at conditions that provide excess water that flushes away contaminants deposited on the cell electrodes. Two techniques are described that both operate the stack at a relatively low temperature and a cathode inlet RH above saturation. The first technique also includes providing hydrogen to the anode side of the stack and air to the cathode side of the stack, and operating the stack at a relatively low cell voltage. The second technique also includes flowing hydrogen to the anode side of the stack and nitrogen to the cathode side of the stack, using an external power source to provide a stack current density, and providing an anode humidity level that is significantly higher than the cathode humidity level.

Additional features of the present invention will become apparent from the following description and appended claims, taken in conjunction with the accompanying drawings.

### BRIEF DESCRIPTION OF THE DRAWINGS

FIG. 1 is a block diagram of a fuel cell system;

FIG. 2 is a flow chart diagram showing one method for recovering loss of cell voltage in a fuel cell stack; and

FIG. 3 is a flow chart diagram showing another method for recovering loss of cell voltage in a fuel cell stack.

### DETAILED DESCRIPTION OF THE EMBODIMENTS

The following discussion of the embodiments of the invention directed to a system and method for recovering cell voltage loss in a PEM fuel cell stack is merely exemplary in nature, and is in no way intended to limit the invention or its applications or uses.

The present invention proposes two techniques for recovering cell voltage loss in a PEM fuel cell that has occurred as a result of catalyst degradation from the deposit of contaminants on the cell electrodes, where the techniques generate significant water that causes anions to desorb from the electrodes and be flushed away. Particularly, liquid water has to be present around the catalyst surface to cause anions to diffuse away and be carried out by the liquid water flux through the stack flow-fields. Both techniques operate the stack at a relatively low temperature and a cathode inlet relative humidity (RH) above saturation. The first technique also includes providing hydrogen to the anode side of the stack and air to the cathode side of the stack, and operating the stack at a relatively low stack voltage potential. The second technique also includes flowing hydrogen gas to the anode side of the stack and nitrogen gas to the cathode side of the stack, using an external power source to provide a stack current density, and providing an anode RH that is significantly higher than the cathode RH.

The algorithms and processes that operate the techniques for recovering cell voltage loss can be performed periodically or at any time suitable for a particular fuel cell system. The techniques can be triggered by any suitable stack condition, such as an average cell voltage falling below a predetermined value, such as 400 mV, for a predetermined period of time. Also, the techniques can be performed at any suitable time, which may not be during a stack run mode, such as during a shut-down sequence or at a service location that is servicing the fuel cell system.

The techniques described herein for recovering cell voltage loss enhance the ability of the fuel cell MEAs to react to the fuel and oxidant because the higher fraction of liquid water enables soluble contaminates to be flushed away, the higher level of membrane electrode saturation increases the proton conductivity of the membrane and electrodes, the reduction in voltage under wet conditions leads to the reduction in the surface coverage of anion type poisoning species, such as sulfates, which then get flushed away during subsequent operation, and the reduction of surface oxides, such as platinum oxide and platinum hydroxide, which expose more of the precious metal sites.

FIG. 1 is a schematic block diagram of a fuel cell system 10 including a fuel cell stack 12 that is able to provide the stack operating conditions for cell voltage loss recovery outlined above. A compressor 16 provides an airflow to the cathode side of the fuel cell stack 12 on a cathode input line 14 through a water vapor transfer (WVT) unit 18 that humidifies the cathode input air. The WVT unit 18 is one type of applicable humidification device, where other types of humidification devices may be applicable for humidifying the cathode inlet air, such as enthalpy wheels, evaporators, etc. A cathode exhaust gas is output from the stack 12 on a cathode exhaust gas line 20 through a back-pressure valve 22. The exhaust gas line 20 directs the cathode exhaust to the WVT unit 18 to provide the humidity to humidify the cathode input air. A by-pass line 28 is provided around the WVT unit 18 to direct some or all of the cathode exhaust gas around the WVT unit 18 in a controlled manner. In an alternate embodiment, the by-pass line 28 can be an inlet by-pass. A by-pass valve 24 is provided in the by-pass line 28 and is controlled to selectively redirect the cathode exhaust gas through or around the WVT unit 18 to provide the desired amount of humidity to the cathode input air. A nitrogen source 26 is also included to provide nitrogen gas to the cathode side of the stack 12.

The anode side of the fuel cell stack 12 receives hydrogen gas from a hydrogen source 32 on an anode input line 30 and provides an anode exhaust gas on line 34 through a valve 36, such as a bleed valve, purge valve, etc. A pump 38 pumps a cooling fluid through the stack 12 and a coolant loop 40 external to the stack 12. A power source 42, such as a battery, is included to provide a current flow through the stack 12.

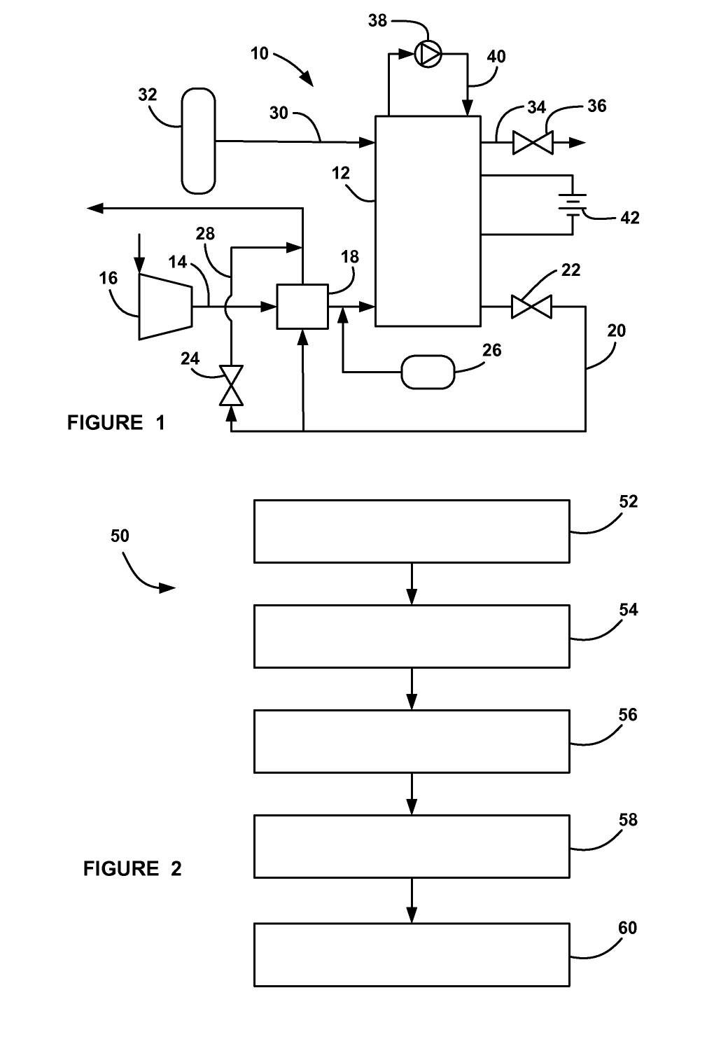

FIG. 2 is a flow chart diagram 50 showing a process for recovering cell voltage loss in a PEM fuel cell stack, according to one embodiment of the present invention. The flow diagram 50 has a number of steps shown in sequential order, however, the diagram 50 is intended to identify a number of stack operating conditions that generate significant water within the stack cells to flush away contaminants deposited on the catalyst surface, where those operations are being performed simultaneously or nearly simultaneously. Further, these stack operating conditions typically will not be performed during the normal run operation of the fuel cell system, but may be performed after or during a system shut-down sequence or at a service location.

At box 52, the stack 12 is operated at a relatively low temperature where significant condensation will occur to generate liquid water in the cells. The desired stack temperature can be achieved by any suitable technique, such as flowing the stack cooling fluid by the pump 38 at a relatively high flow rate and at a low stack power output. In one non-limiting embodiment, the temperature of the stack 12 is set to be less than 60° C., and preferably less than 30° C. Further, reactive flows are provided to the cathode side and the anode side of the stack 12, particular air to the cathode side and hydrogen gas to the anode side at a flow rate for the desired stack power output. The reactant gas flow is set so that the stack 12 operates at a relatively low average cell voltage at box 56, which generates stack water from the reaction that is also available to wash away contaminates from the cell electrodes. In one non-limiting example, the average cell voltage is set to be less than 650 mV, and preferably less than 300 mV. The stack inlet relative humidity is also set to be above saturation, for example, 110%, to provide more stack water. The RH inlet relative humidity may be provided by the WVT unit 18 for the cathode side, and, if the process is being performed at a service location, humidity can be provided to the anode side as well at or about the same saturation value. Further, the system controller adjusts the cathode and/or anode outlet pressures, such as by the valves 22 and 36, respectively, and the hydrogen gas and air flow rates to provide a cathode and anode stoichiometry and operating conditions that provide the power consumed relative to the reactant gas flow to meet the requirements for the system operation at box 60.

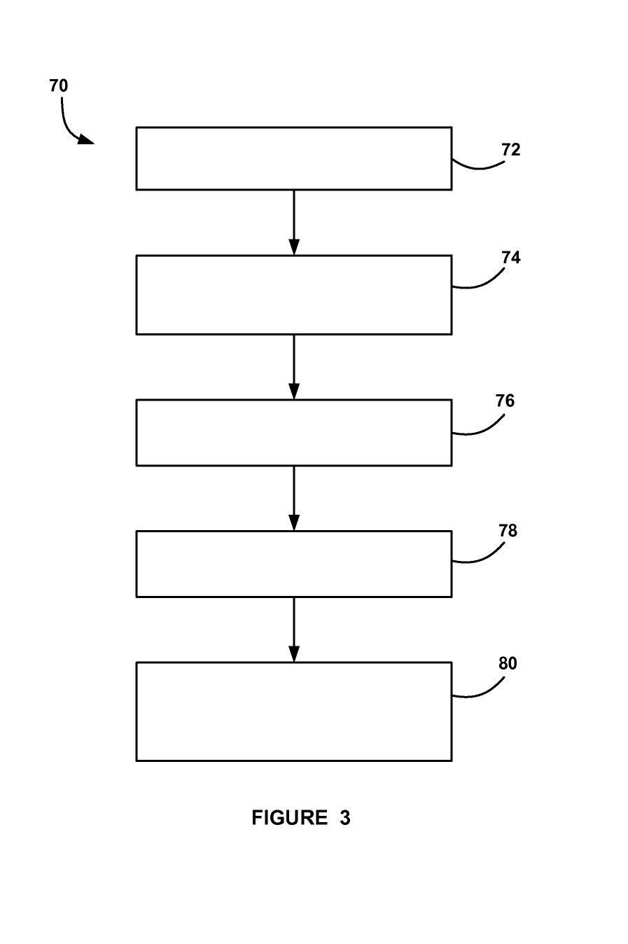

FIG. 3 is a flow chart diagram 70 showing a technique for recovering cell voltage loss, according to another embodiment of the present invention. As above, the flow chart diagram 70 shows several steps, but each of the operations are performed simultaneously or nearly simultaneously. Further, this embodiment may be required to be performed at a service center.

At box 72, the stack 12 is operated at a relatively low temperature where significant condensation will occur to generate liquid water in the cells. The desired stack temperature can be achieved by any suitable technique, such as flowing the stack cooling fluid by the pump 38 at a relatively high flow rate and at a low stack power output. In one non-limiting embodiment, the temperature of the stack 12 is set to be less than 60° C., and preferably less than 30° C. At box 74, hydrogen gas is provided to the anode side of the stack 12 and nitrogen gas, such as from the source 26, is provided to the cathode side of the stack 12. The stack inlet humidification is set above saturation at box 76, where the inlet relative humidity for the anode side is set to be greater than the inlet humidification for the cathode side. The nitrogen gas provides the mechanism by which the inlet relative humidity for the cathode side can be drawn into the stack 12. In one non-limiting embodiment, the anode side inlet humidity is set to about 220% and the cathode side inlet humidity is set to about 110%. At box 78, an external power source, such as the power source 42, applies a potential to the stack 12 to generate a drive current through the stack 12 to provide a voltage on each cell within the stack 12. In one non-limiting embodiment, the drive current is in the range of 0.1-0.5 A/cm², which generates a slightly negative voltage in the cells, where an individual cell voltage may be 10 to 50 mV.

Further, the flow rates to the anode side and the cathode side are selected and adjusted at box 80 so that enough inlet water is sent to the anode side of the stack 12 to cover the water transport from the anode side to the cathode side of the fuel cells that occurs as a result of electro-osmotic drag. Because the stack 12 is not generating water through the electro-chemical reaction, the water used to flush out the contaminates is mostly from the liquid water that is brought into the stack 12 from the cathode and anode flow streams. Thus, the flow rates of the hydrogen gas and the nitrogen gas need to be controlled so that the water that moved from the anode side to the cathode side as a result of electro-osmotic drag can be sustained without drying out the anode side of the membranes.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for recovering voltage loss of fuel cells in a fuel cell stack, said method comprising:
operating the fuel cell stack at a stack temperature that is less than 60° C.;
providing hydrogen gas to an anode side of the fuel cell stack;
providing a gas flow to a cathode side of the fuel cell stack; and
providing humidity to the gas flow so that the relative humidity of the gas flow is above saturation, wherein the condensation generated in the stack as a result of operating the stack at the stack temperature and liquid water provided by the saturated gas flow provide a water flow in fuel cell flow-fields that flush away contaminates deposited on electrodes in the fuel cells.

2. The method according to claim 1 wherein providing a gas flow includes providing cathode air to the cathode side so that the fuel cell stack generates power to provide stack water that also removes the contaminates.

3. The method according to claim 2 wherein generating fuel cell stack power includes providing an average cell voltage less than 650 mV.

4. The method according to claim 3 wherein generating fuel cell stack power includes providing an average cell voltage less than 300 mV.

5. The method according to claim 2 further comprising controlling a cathode exhaust outlet pressure in combination with the hydrogen gas flow rate to the anode side and the air flow rate to the cathode side to provide the desired stack temperature and average fuel cell voltage.

6. The method according to claim 1 wherein providing a gas flow to the cathode side includes providing a nitrogen gas flow.

7. The method according to claim 1 further comprising providing a drive current to the fuel cell stack from an external power source so that the fuel cells in the stack have a relatively small negative voltage.

8. The method according to claim 7 where the drive current is between 0.1 and 0.5 A/cm².

9. The method according to claim 1 further comprising providing humidity to the hydrogen gas so that the anode inlet relative humidity is significantly greater than the cathode inlet relative humidity of the gas flow.

10. The method according to claim 9 wherein the relative humidity of the gas flow is about 110% and the relative humidity of the hydrogen gas is about 220%.

11. The method according to claim 1 further comprising adjusting the flow rates of the hydrogen gas and the gas flow so that the amount of water brought into the anode side of the fuel cell stack overcomes water transport from the anode side to the cathode side of the fuel cell stack due to electro-osmotic drag.

12. The method according to claim 1 wherein operating the fuel cell stack at a temperature less than 60° C. includes operating the stack at a temperature less than 30° C.

13. A method for recovering voltage loss of fuel cells in a fuel cell stack, said method comprising:
operating the fuel cell stack at a stack temperature that is significantly less than a normal stack operating temperature;
providing hydrogen gas to an anode side of the fuel cell stack;
providing an air flow to a cathode side of the fuel cell stack;
providing humidity to the cathode air flow so that the relative humidity of the airflow is above saturation;
operating the stack to provide an average cell voltage less than 650 mV; and
adjusting an outlet pressure of a cathode exhaust from the fuel cell stack and flow rates of the hydrogen gas and cathode air flow so that the combination of the temperature of the stack, the average voltage of the fuel cells in the stack, the humidity level of the cathode airflow and the cathode exhaust outlet pressure provide a water flow in fuel cell flow-fields that flushes away contaminants deposited on electrodes in the fuel cells.

14. The method according to claim 13 wherein operating the stack to provide an average cell voltage includes providing an average cell voltage less than 300 mV.

15. The method according to claim 13 wherein operating the fuel cell stack at a stack temperature includes operating the stack at a temperature less than 30° C.

16. The method according to claim 13 wherein providing humidity to the cathode air flow includes providing humidity to the cathode air flow so that the relative humidity of the cathode air flow entering the fuel cell stack is about 110% or greater.

17. A method for recovering voltage loss of fuel cells in a fuel cell stack, said method comprising:
operating a fuel cell stack at a stack temperature that is significantly less than a normal operating temperature of the fuel cell stack;
providing hydrogen gas to an anode side of the fuel cell stack;
providing nitrogen gas to a cathode side of the fuel cell stack;
providing humidity to both the hydrogen gas and the nitrogen gas so that the relative humidity of the gas is above saturation, and where the relative humidity of the hydrogen gas is significantly greater than the relative humidity of the nitrogen gas;
providing a drive current to the fuel cell stack from an external power source so that the fuel cells in the stack have a relatively small negative voltage; and
adjusting the flow rates of the hydrogen gas and the nitrogen gas so that the amount of water brought into the anode side of the fuel cell stack overcomes water transport from the anode side to the cathode side of the fuel cell stack due to electrode-osmotic drag.

18. The method according to claim 17 wherein operating a fuel cell stack at a stack temperature includes operating the stack at a temperature less than 30° C.

19. The method according to claim 17 wherein the relative humidity of the gas flow is about 110% and the relative humidity of the hydrogen gas is about 220%.

20. The method according to claim 17 where the drive current is between 0.1 and 0.5 A/cm².
